(19) United States
(12) Patent Application Publication
(10) Pub. No.: US 2013/0209756 A1
(43) Pub. Date: Aug. 15, 2013

(54) Multilayer Polymeric Film

(71) Applicants: JoAnn Helen Squier, Bloomfield, NY (US); Benoit Ambroise, Hachy (BE); Mark W. Lockhart, Fairport, NY (US)

(72) Inventors: JoAnn Helen Squier, Bloomfield, NY (US); Benoit Ambroise, Hachy (BE); Mark W. Lockhart, Fairport, NY (US)

(21) Appl. No.: 13/701,184

(22) PCT Filed: May 11, 2011
(86) PCT No.: PCT/US11/36073

§ 371 Date: Feb. 18, 2013

Related U.S. Application Data
(60) Provisional application No. 61/358,684, filed on Jun. 25, 2010.

(51) Int. Cl. G09F 3/10; B32B 3/10; G09F 3/00; B32B 27/08; B29C 47/06

(52) U.S. Cl. CPC G09F 3/10; B32B 27/08; B29C 47/065; G09F 3/0286; B32B 3/10
USPC 428/195.1; 428/446; 428/220; 428/447; 428/451; 264/173.14; 264/148; 264/129

(57) ABSTRACT

Provided is a film including: (a) an intermediate layer comprising a polymer and an antistatic agent, said intermediate layer having a first side and a second side; (b) a first layer including a polymer, said first layer being on the first side and is printed or printable; and (c) a second layer including a polymer and a non-migratory slip agent, said second layer being on the second side, wherein the film has at least one of (i) a thickness of at least about 30 μm, (ii) a static coefficient of friction of about 0.15 to less than 0.30, and (iii) a kinetic coefficient of friction of about 0.15 to less than 0.30. Also provided are a method for producing such a film, and labels such as cut and stack labels comprising the film.

### CROSS REFERENCE OF RELATED APPLICATIONS

This application claims priority from U.S. Provisional Application No. 61/358,684, filed Jun. 25, 2010, the contents of which are incorporated by reference in their entirety.

### FIELD OF THE INVENTION

The invention relates to multilayer polymeric films. More particularly, the invention relates to multilayer polymeric films having antistatic properties which render the films especially suitable for use in cut and stack label applications. The invention also relates to methods for making the films and cut and stack labels comprising such films.

### BACKGROUND

There is a growing consumer preference for food, beverage and household products packaged in plastic containers. This is because plastic containers offer a number of convenient benefits including portability, resealability, safety, lightweight, and contourability for comfortable grip. Plastic containers are particularly durable and can withstand more demanding consumer environments, such as an ice chest, as well as withstand a drop to the ground of perhaps six feet or more. For label manufacturers, this means packaged goods companies prefer labels to be water proof, scuff proof, extremely durable, resistant to scuffing and product deterioration, able to withstand drops of six feet or more without tearing, and aesthetically pleasing to the consumer's eye and touch, for the life of the use of the container. Thus, for these manufacturers, an effective process for applying plastic labels to containers becomes increasingly important.

A number of methods exist for applying labels to containers. This includes employing continuous roll-fed labels or using cut-and-stack labels. Methods employing labels in continuous roll form include label cutting and registration means for severing discrete labels from a roll, and then registering them for attachment to the containers through a vacuum transfer drive system. In the cut-and-stack or sheet-fed label method, labels are cut offline and kept in a stack to be fed to a dispensing magazine, which then applies the labels to containers in a continuous application system. Because of the additional degree of manipulation associated with the cutting, stacking, and feeding process, sheet-to-sheet interaction between the print and non-print surface of the labels are more important in the cut-and-stack label method compared to the roll-fed method.

Cut-and-stack labels in the beverage container market have typically been largely paper, but there is an increasing interest in using plastic labeling film. However, because film is typically lighter than paper, manipulating film labels is more challenging than paper labels, especially with stacking and feeding at high speeds. For example, if the film is not heavy enough, the sheets will “float” instead of land properly onto a stack. The film also needs to be of sufficient stiffness so that the sheets can be stacked and positioned without crumpling or deforming. Further, plastic films, unlike paper which is capable of absorbing moisture, are more susceptible to static effects during processing. If the coefficient of friction (COF) is too high, the sheets will stick to each other, which makes sheet stacking and feeding difficult. However, if the coefficient of friction is too low, the sheets will slide off too easily, thus hindering sheet stacking and positioning.

One film currently used in the cut-and-stack label film is an ethylene-propylene/polypropylene/ethylene-propylene copolymer structure, with high levels of migrating slip agent. However, high levels of migratory slip agents can interfere with performance during hot melt adhesion.

Biaxially oriented polypropylene films including migratory slip additives that may be used for cut-and-stack label applications include those marketed as Treofan ETH57 and Amtopp TA57. Other films that may be useful for as cut-and-stack wraparound labels are white and clear coated films marketed as Lithor™ 65LT447 and 50LTG702, and Label-Lyte™ (47LL247), a white film with an antistatic lacquer. References relating to multilayer films include U.S. Pat. Nos. 6,074,762; 6,087,015; 6,472,077; and 6,682,822.

There is a need for films having a combination of properties (e.g., thickness, stiffness, antistatic) that render them suitable for use in the labeling market, especially in cut-and-stack applications.

### SUMMARY OF THE INVENTION

In one embodiment, the invention encompasses a film comprising: (a) an intermediate layer comprising a polymer and an antistatic agent, said intermediate layer having a first side and a second side; (b) a first layer comprising a polymer, said first layer being on the first side and is printed or printable; and (c) a second layer comprising a polymer and a non-migratory slip agent, said second layer being on the second side, wherein the film has at least one of (i) a thickness of at least about 30 μm, (ii) a static coefficient of friction of about 0.15 to less than 0.30, and (iii) a kinetic coefficient of friction of about 0.15 to less than 0.30.

In one embodiment, the invention encompasses a film comprising: (a) an intermediate layer comprising an isotactic polypropylene homopolymer and an antistatic agent comprising at least one of an alkali metal sulfonate, a polyether-modified polydiorganosiloxane, or a tertiary amine, said intermediate layer having a first side and a second side; (b) a first layer comprising a propylene-ethylene random copolymer, said first layer being on the first side and is printed or printable; and (c) a second layer comprising an ethylene-propylene copolymer and silicone gum, said second layer being on the second side, wherein the silicone gum is in an amount of about 0.1% to about 1% by weight of the second layer, wherein the cut-and-stack film has a stiffness of at least about 10 Gurley in MD and at least about 20 Gurley in TD, a thickness of at least about 50 μm, a static coefficient of friction of about 0.17 to about 0.25, and a kinetic coefficient of friction of about 0.17 to about 0.25.

In another embodiment, the invention encompasses a method for producing a film, comprising: (a) providing an intermediate layer comprising a polymer and an antistatic agent, said intermediate layer having a first side and a second side; (b) providing a first layer comprising a polymer, said first layer being printed or printable; (c) providing a second layer comprising a polymer and a non-migratory slip agent; and (d) forming a film wherein the first layer is on the first side of the intermediate layer and the second layer is on the second side of the intermediate layer, wherein the film has at least one of (i) a thickness of at least about 30 μm, (ii) a static coefficient of friction of about 0.15 to less than 0.30, and (iii) a kinetic coefficient of friction of about 0.15 to less than 0.30. The invention also encompasses films and labels made according to methods of the invention.

### DETAILED DESCRIPTION OF PREFERRED EMBODIMENTS

The invention aims to solve common problems described above with label film sheeting, stacking, and feeding, as well as present an environmentally friendly option based on its yield advantage. In one aspect, the invention provides a multilayer film having an antistatic agent in the intermediate layer and a non-migratory slip agent in another layer located on the non-print side of the intermediate layer. This combination provides advantageous antistatic and COF properties to the film, as seen in various phases of film production, such as from winding and slitting through the converter processes of sheeting, printing, and feeding of labels. These advantages are particularly beneficial in the roll-to-sheet printing and cut-and-stack label feeding process. These improved processing attributes are especially applicable to thin solid webs, and improved COF stability provides an additional advantage for Fitness For Use (FFU) with hot melt adhesion. In some embodiments, increased film gauge contributes to greater stiffness which further enhances sheeting and feeding performance. In addition, the print surface of these films is compatible with different ink technologies, for example, UV gravure offset lithography printing. Thus, films of the invention, which can be clear or opaque, are particularly suitable for applications in the polyethylene terephthalate (PET), polyethylene (PE), or other bottled beverage market (e.g., water, juice, sport and functional beverages).

Various specific embodiments, versions and examples of the invention will now be described, including preferred embodiments and definitions that are adopted herein for purposes of understanding the claimed invention. While the following detailed description gives specific preferred embodiments, those skilled in the art will appreciate that these embodiments are exemplary only and that the invention can be practiced in other ways. For purposes of determining infringement, the scope of the invention will refer to any one or more of the appended claims, including their equivalents, and elements or limitations that are equivalent to those that are recited. Depending on the context, references below to the “invention” may in some cases refer to certain specific embodiments only. In other cases it will be recognized that references to the “invention” will refer to subject matter recited in one or more, but not necessarily all, of the claims. Headings used herein are for reference only and are not intended to limit any aspect of the invention.

As used herein, the term “opaque” in reference to a film refers to a film that is translucent and/or contains voids.

As used herein, the term “polymer” refers to the product of a polymerization reaction, and includes homopolymers, copolymers, terpolymers, etc.

As used herein, the term “copolymer(s)” refers to polymers formed by the polymerization of at least two different monomers. For example, the term “copolymer” includes the copolymerization reaction product of propylene and an alpha-olefin (α-olefin), such as ethylene. However, the term “copolymer” is also inclusive of, for example, the copolymerization of a mixture of more than two monomers, such as, ethylene-propylene-butene.

As used herein, “cut-and-stack” refers to a process where film labels are pre-cut, typically kept in the form of a sheet stack, and fed to a dispensing magazine which applies the labels to containers, preferably in a continuous application system.

In one embodiment, the invention encompasses a film comprising: (a) an intermediate layer comprising a polymer and an antistatic agent, said intermediate layer having a first side and a second side; (b) a first layer comprising a polymer, said first layer being on the first side and is printed or printable; and (c) a second layer comprising a polymer and a non-migratory slip agent, said second layer being on the second side, wherein the film has at least one of (i) a thickness of at least about 30 μm, (ii) a static coefficient of friction of about 0.15 to less than 0.30, and (iii) a kinetic coefficient of friction of about 0.15 to less than 0.30.

In another embodiment, the invention encompasses a method for producing a film, comprising: (a) providing an intermediate layer comprising a polymer and an antistatic agent, said intermediate layer having a first side and a second side; (b) providing a first layer comprising a polymer, said first layer being printed or printable; (c) providing a second layer comprising a polymer and a non-migratory slip agent; and (d) forming a film wherein the first layer is on the first side of the intermediate layer and the second layer is on the second side of the intermediate layer, wherein the film has at least one of (i) a thickness of at least about 30 μm, (ii) a static coefficient of friction of about 0.15 to less than 0.30, and (iii) a kinetic coefficient of friction of about 0.15 to less than 0.30.

In a preferred embodiment, the method further comprises (e) cutting the film into sheets; and (f) forming a stack of sheets suitable for feeding to a cut-and-stack labeling equipment. Preferably, the method further comprises (g) feeding the sheets into a cut-and-stack labeling equipment; and (h) printing the sheets on the side of the first layer.

Preferably, the film is in the form of a sheet suitable for feeding to a cut-and-stack labeling equipment. Preferably, the film has a thickness of at least about 30 μm, a static coefficient of friction of about 0.15 to less than 0.30, and a kinetic coefficient of friction of about 0.15 to less than 0.30. Preferably, the film has a stiffness of at least about 10 Gurley, preferably about 10 to about 50 Gurley, about 10 to about 20 Gurley, and more preferably about 10 to about 15 Gurley in MD. Preferably, the film has a stiffness of at least about 20 Gurley, preferably about 20 to about 50 Gurley, about 20 to about 40 Gurley, and more preferably about 20 to about 30 Gurley in TD. Preferably, the film has a thickness of at least about 50 μm, preferably about 50 to about 100 μm, about 50 to about 70 μm, and more preferably about 50 to about 60 μm.

The static and kinetic coefficients of friction are film-to-film and are between the I/I, I/O, and O/O surfaces. Preferably, the coefficient of friction is between the I/O surfaces. Preferably, the film has a static coefficient of friction of about 0.17 to about 0.25, or about 0.17 to about 0.22. Preferably, the film has a kinetic coefficient of friction of about 0.17 to about 0.25, or about 0.17 to about 0.22.

Preferably, the antistatic agent comprises at least one of an alkali metal sulfonate, a polyalkylphenylsiloxane, or a tertiary amine. Preferably, the antistatic agent is present in an amount of about 0.01% to about 2% by weight of the intermediate layer.

Preferably, the non-migratory slip agent comprises silicone gum. Preferably, the non-migratory slip agent is present in an amount of about 0.1% to about 1% by weight of the second layer.

Preferably, the polymer in the intermediate layer comprises at least one of a polypropylene homopolymer, polyethylene, ethylene-propylene copolymer, propylene-butene copolymer, or ethylene-propylene-butylene terpolymer. Preferably, the intermediate layer further comprises a cavitating agent.

Preferably, the polymer in at least one of the first and second layers comprises at least one of a polypropylene homopolymer, polyethylene, ethylene-propylene copolymer, propylene-butene copolymer, or ethylene-propylene-butylene terpolymer. Preferably, at least one of the first and second layers further comprises an antiblocking agent.

In one preferred embodiment, the film comprises (a) an intermediate layer comprising an isotactic polypropylene homopolymer and an antistatic agent comprising at least one of an alkali metal sulfonate, a polyether-modified polydiorganosiloxane, or a tertiary amine, said intermediate layer having a first side and a second side; (b) a first layer comprising a propylene-ethylene random copolymer, said first layer being on the first side and is printed or printable; and (c) a second layer comprising an ethylene-propylene copolymer and silicone gum, said second layer being on the second side, wherein the silicone gum is in an amount of about 0.1% to about 1% by weight of the second layer, wherein the cut-and-stack film has a stiffness of at least about 10 Gurley in MD and at least about 20 Gurley in TD, a thickness of at least about 50 μm, a static coefficient of friction of about 0.17 to about 0.25, and a kinetic coefficient of friction of about 0.17 to about 0.25.

In one embodiment, the film further comprises a third layer between the first layer and the intermediate layer or between the second layer and the intermediate layer.

The invention also encompasses labels comprising the film, and films and labels made according to methods of the invention. Preferably, the label is a cut-and-stack label.

### Intermediate Layer

The films of the invention comprise an intermediate layer. As used herein, “intermediate” refers to the position of one layer of a multilayer film wherein said layer lies between two other identified layers. In some embodiments, the intermediate layer is in direct contact with either or both of the two identified layers. In other embodiments, additional layers are present between the intermediate layer and either or both of the two identified layers.

The intermediate layer has a first side and a second side. In one embodiment, the intermediate layer comprises a polymer, preferably a thermoplastic polymer, and an antistatic agent.

Preferably, the intermediate layer comprises a thermoplastic polymer having properties suitable for extrusion or coextrusion, followed by biaxial orientation in the machine and transverse directions under elevated temperature so as to form a multi-layer film. In some embodiments, the polymer comprises a polyolefin. The polyolefin may be selected from polypropylene, polyethylene, ethylene-propylene copolymers, propylene-butene copolymers, ethylene-propylene-butylene terpolymers, and blends thereof. The polyolefin may be produced by Ziegler-Natta catalyst, metallocene catalyst, or any other suitable means.

In some embodiments, the polymer is made from a C₂₋₄ olefin, such as ethylene or butene-1, or a polymer made predominantly of propylene with minor amounts of another olefin, usually a C₂₋₄ olefin. In a preferred embodiment, the polymer is a polypropylene homopolymer.

The polyethylene may be high density polyethylene (“HDPE”), medium density polyethylene (“MDPE”), low density polyethylene (“LDPE”), linear low density polyethylene (“LLDPE”), and combinations thereof. In one embodiment, the polymer is HDPE, having a density of about 0.940 g/cm³ or more, or preferably 0.952 g/cm³ or more. The HDPE may have a density in the range of about 0.952 to about 0.962 g/cm³; and a melt index (“MI”) in the range of about 0.001 to about 10.0 g/10 min, or preferably in the range of about 0.01 to about 2.0 g/10 min; and a crystalline melting temperature Tm in the range of about 130 to about 148° C. In another embodiment, the film comprises MDPE having a density in the range of about 0.926 to about 0.940 g/cm³. In yet another embodiment, the polymer is LDPE having a density of about 0.926 g/cm³ or less, or in the range of 0.89 to 0.93 g/cm³, and a MI of about 7 g/10 min, or in the range of about 6 to about 9 g/10 min. In a further embodiment, the polymer is LLDPE having a density in the range of about 0.90 to about 0.94 g/cm³, or more preferably in the range of about 0.910 to about 0.926 g/cm³. The LLDPE may have a MI in the range of about 1 to about 10 g/10 min. The LLDPE may be a copolymer of ethylene and a minor amount of a higher olefin comonomer containing 4 to 10 carbon atoms, such as for example, butene-1, hexene-1, or octene-1.

The polypropylene can have a MFR in the range from 0.001 to 10 g/10 min, or preferably 0.01 to 5 g/10 min, selected from isotactic polypropylene (“iPP”), syndiotactic polypropylene (“sPP”), high crystalline polypropylene (“HCPP”), beta-nucleated polypropylene (“β-PP”), and blends thereof. Preferred polypropylenes have a crystallinity in the range of about 30 to about 80% and a Tm in the range of about 140 to about 170° C. The iPP may have an isotacticity of 89% or greater, preferably 90% or greater, as measured by the fraction of mesopentad (“m-pentad”) with ¹³C-NMR. The mesopentad fraction refers to the portion of isotactic conformation in the entire conformation. The sPP may have a syndiotacticity of 89% or greater, as measured by the fraction of racemic pentads (“r-pentad”) with ¹³C-NMR. The mean length of the syndiotactic sequences may be greater than 20 and preferably, greater than 25.

In one embodiment, the polyolefin is β-PP, as described in U.S. Pat. No. 6,828,019, the entirety of which is incorporated herein by reference. Beta nucleation includes creating beta-form crystals of polypropylene comprising a beta-crystalline nucleating agent. Substantially any beta-crystalline nucleating agent (“beta nucleating agent” or “beta nucleator”) may be used, as disclosed in U.S. Pat. Nos. 4,386,129; 4,975,469; 5,681,922; 5,231,126; 5,491,188; 6,235,823; and 6,005,034. The amount of beta nucleators to be used may be from 0.0002 to 8%, and preferably 0.01 to 2%, based on the weight of polypropylene.

The ethylene-propylene copolymers (which may also be referred to as propylene-ethylene copolymer) can have a MFR of less than or equal to 10 g/10 min, comprising ethylene-propylene mini-random copolymer, ethylene-propylene random copolymer, ethylene-propylene block copolymers, and blends thereof. Preferably, the comonomer is selected from one or more of ethylene or butene. In such co- or terpolymers, the propylene monomer can be present at greater than or equal to 90 wt %.

In a preferred embodiment, the polyolefin is selected from HDPE, iPP, HCPP, β-PP, ethylene-propylene copolymers, and blends thereof.

### Antistatic Agent

The intermediate layer comprises an antistatic agent. Useful antistatic agents include alkali metal sulfonates, polyether-modified polydiorganosiloxanes, polyalkylphenylsiloxanes and tertiary amines. The antistatic agent may be selected from, e.g., glycerol monostearate (GMS) and a blend of GMS and tertiary amine. A preferred antistatic resin includes a tertiary ethoxylated amine such as those marketed as Armostat 475 by AkzoNobel Polymer Chemicals. Suitable amounts for the antistatic agent may range from about 0.05% to about 3%, preferably about 0.01% to about 2%, or about 0.01% to about 1%, and more preferably about 0.1 to 0.2% by weight of the intermediate layer. The antistatic agent may also be present in the first, second and/or any other layers.

### First Layer

The first layer is located on the first side of the intermediate layer and is printed or printable. As used herein, a layer “being on” a particular side of another layer (e.g., “the first layer being on the first side of the intermediate layer”) refers only to the location of that layer with respect to the other layer; the phrase “being on” does not require that layer to be directly adjacent to, or in full or partial contact with, the other layer, and includes embodiments with tie layers between the two layers described (e.g., between the first layer and the intermediate layer).

As used herein, the term “printable” means having suitable properties to permit good quality printed results, such as uniformity of printed color, uniformity of ink transfer, good quality of black-and-white image, and consistency of ink drying and setting (See Encyclopedia of Labels and Label Technology, M. Fairley, Taurus Publishing Ltd.). A layer may be treated so as to provide printability. This includes surface treatment of any kind to enhance the surface tension properties such as flame or corona treatment. The layer may be treated by surface treatment which improves wettability and adhesion of printed matter (print may be by lithography, liquid or dry toner, thermal dyes, dye sublimation, etc.). Other treatment methods include the application of a printable covering layer by way of any conventional extrusion or coating method. Certain water-based coatings are known for their utility as printable coatings. Examples include acrylic-based coatings including alkyl acrylate polymers and copolymers.

The first layer comprises a polymer which may be the same as or different from the polymer in the intermediate layer and/or the second layer. In a preferred embodiment, the first layer comprises a polymer having properties suitable for extrusion and uniaxial or biaxial orientation (by stretching the extrudate in the machine and/or transverse directions under elevated temperatures), and preferably for forming skin layers on the outer surfaces of the intermediate layer.

Suitable polymers include an olefinic polymer, such as polypropylene or polyethylene. Other suitable polymers include a copolymer or terpolymer of ethylene, propylene and/or butylene and/or another olefin having 5 to 10 carbon atoms or a mixture of these olefin polymers. Preferably, the polymer in the first layer comprises at least one of a polypropylene, polyethylene, ethylene-propylene copolymer, propylene-butene copolymer, or ethylene-propylene-butylene terpolymer. In one preferred embodiment, the polymer is a propylene-ethylene random copolymer marketed as Fina 8573 and manufactured by ATOFINA Petrochemicals, LaPorte, Tx. 77571.

Preferably, the first layer comprises an ethylene homopolymer having a density of about 0.91 to about 0.96 g/cm³, an ethylene-propylene copolymer in which the ethylene content is about 2 to about 10% based upon the total weight of the copolymer, or an ethylene-propylene-butylene terpolymer in which the ethylene content is about 0.5 to about 7% ethylene and about 5 to about 30% butylene, each based upon the total weight of the terpolymer.

### Second Layer

The second layer is located on the second side of the intermediate layer and comprises a polymer and a non-migratory slip agent. The polymer in the second layer may be the same as or different from the polymer in the intermediate layer and/or the first layer. In a preferred embodiment, the second layer comprises a polymer having properties suitable for extrusion and uniaxial or biaxial orientation (by stretching the extrudate in the machine and/or transverse directions under elevated temperatures) and for forming skin layers on the outer surfaces of the intermediate layer.

Suitable polymers include an olefinic polymer, such as polypropylene or polyethylene. Other suitable polymers include a copolymer or terpolymer of ethylene, propylene and/or butylene and/or another olefin having 5 to 10 carbon atoms or a mixture of these olefin polymers. Preferably, the polymer in the second layer comprises at least one of a polypropylene, polyethylene, ethylene-propylene copolymer, propylene-butene copolymer, or ethylene-propylene-butylene terpolymer. In one preferred embodiment, the polymer is a propylene-ethylene random copolymer marketed as Fina 8573 and manufactured by ATOFINA Petrochemicals, LaPorte, Tx. 77571.

Preferably, the second layer comprises an ethylene homopolymer having a density of about 0.91 to about 0.96 g/cm³, an ethylene-propylene copolymer in which the ethylene content is about 2 to about 10% based upon the total weight of the copolymer, or an ethylene-propylene-butylene terpolymer in which the ethylene content is about 0.5 to about 7% ethylene and about 5 to about 30% butylene, each based upon the total weight of the terpolymer.

### Non-Migratory Slip Agent

Coextruded biaxially oriented films typically contain migratory slip additives (such as fatty acid amides) incorporated in the main central layer. Over time, the slip additive migrates to the surface of the film, thereby affecting the film's slip properties. One issue encountered with migratory slip additives is that the film's slip properties tend to increase with time due to the slip additive accumulating on the film surface. Such an increase in slip properties can cause the film to have poor performance when used in high-speed packaging machinery because the films have become too slippery. In addition, accumulating migratory slip additive on the film surface tends to reduce the optical characteristics of the films (e.g., increased haze and reduced gloss). As an alternative to the use of migratory slip additives it has been proposed to use non-migratory slip agents, such as silicone oil, which can be compounded into outer layer(s) of the film. High molecular weight silicone oil is non-migratory since the slip properties of film remain constant with time. The slip properties of the film are a function of the amount of silicone at the surface of the film when it is made.

The second layer of the film of this invention comprises a non-migratory slip agent. As used herein, a “non-migratory” slip agent is a slip agent that generally does not change location throughout the layers of the film in the manner of the migratory slip agents such as polydialkyl siloxane and fatty amides. Exemplary non-migratory slip agents include polydimethylsiloxane block copolymer and crosslinked hydrocarbyl-substituted polysiloxane. A preferred non-migratory slip agent is silicone oil or gum, or an ultra-high molecular weight siloxane polymer dispersed in polypropylene (PP) homopolymer, marketed as MB50-001 by the Dow Corning Corporation.

Suitable amounts for the non-migratory slip agent may range from about 0.1 to 2%, preferably about 0.1 to about 1%, and more preferably about 0.2 to about 0.7%, by weight of the second layer. The non-migratory slip agent may also be present in the first, intermediate and/or any other layers.

### Antiblocking Agent

The multilayered film may also contain an antiblocking agent. Suitable antiblocking agents include fully crosslinked or non-meltable polysiloxane, polymethyl methacrylate (PMMA) particles such as Epostar® MA-1002 or silica particles such as Sylobloc 44 from W. R. Grace. In a preferred embodiment, the antiblocking agent is in the form of spherical particulates. Preferably, the antiblocking agent is a fully crosslinked or non-meltable polysiloxane. Preferably, the fully crosslinked or non-meltable polysiloxane is polymethylsilsesquioxane, which comes in a spherical powder form having an average particle size of from about 2 μm to about 6 μm. Suitable fully crosslinked or non-meltable polysiloxanes include, Tospearl T120A, which is a fully crosslinked, non-meltable silicone resin powder available from Toshiba Silicone Company, Ltd.

Preferably, the antiblocking agent is present in an amount of from about 0.1 to about 0.5%, preferably from about 0.15 to about 0.30%, by weight of the layer in which it is incorporated. The antiblocking agent may be incorporated into any layer of the film, preferably in the second layer.

### Additional Additives

Sometimes it is useful to enhance or provide the film with certain properties by use of appropriate film additives in various layers. Such additives are used in effective amounts, which vary depending upon the property required, and typically include antistatic, antiblocking, migratory or non-migratory slip, antioxidant, moisture and/or gas barrier additives. These additives may be added to one or more layers of the film according to the present invention.

Slip agents include higher aliphatic acid amides, higher aliphatic acid esters, waxes and metal soaps, which may be used in amounts of from about 0.1 to about 2% based on the total weight of the layer. A specific example of a fatty amide slip agent is erucamide. Useful antioxidants, such as phenolic antioxidants, are generally used in amounts of from about 0.1 to about 2%, based on the total weight of the layer. One useful antioxidant is commercially available under the trademark IRGANOX 1010. Useful antiblocking agents, which may be present in amounts of from about 0.1 to about 3% based upon the entire weight of the layer, include inorganic particulates such as silicon dioxide, e.g., a particulate antiblocking sold by W. R. Grace under the trademark SYLOBLOC 44, Sipernat from Degussa, calcium carbonate, magnesium silicate, aluminum silicate, calcium phosphate, and the like (e.g., KAOPOLITE). A useful particulate antiblocking agent is TOSPEARL made by Toshiba Silicone Co., Ltd. Another useful antiblocking agent is a spherical particle made from methyl methacrylate resin having an average diameter of 1 to 15 microns, and such an additive is sold under the trademark EPOSTAR and is commercially available from Nippon Shokubai. Barrier additives may include low-molecular weight resins, hydrocarbon resins, particularly petroleum resins, styrene resins, cyclopentadiene resins and terpene resins. Optionally, the outer layers may be compounded with a wax for lubricity. Amounts of wax may be from about 2 to about 15% based on the total weight of the layer.

### Opaque Films

The films of the invention may be clear or opaque. In one embodiment, the film is opaque and comprises a cavitating agent. The cavitating agent may include a group of organic and inorganic materials including, for example, polybutylene teraphthalate (“PBT”), polyethylene terephthalate (“PET”), poly(ethylene 2,6-napthalate) (“PEN”), polycarbonate, polycarbonate alloy, nylon, cross-linked polystyrene, syndiotactic polystyrene, acetal, acrylic resins, polyacrylate, poly (N-vinylcarbozole), polyvinylcyclohexane, polyvinyl chloride, polyacrylonitrile, cyclic olefinic polymer, aliphatic polyketone, poly(4-methyl-1-pentene), ethylene vinyl alcohol copolymers, polysulfones, cross-linked polystyrene, cross-linked silicone polymers, solid or hollow pre-formed glass or polymer spheres, metal beads or spheres, ceramic spheres, calcium carbonate, talc, chalk, or combinations thereof. One cavitating agent is a cyclic olefinic polymer selected from a cyclic olefin homopolymer (“COH”), a cyclic olefin copolymer (“COC”), and blends thereof COC is a copolymer comprising two monomers; one monomer being a cyclic olefin, such as a C₄ to C₁₂ cyclic olefin or norbornene, and the second monomer being an aliphatic olefin, such as ethylene, propylene, and butylene. The COC copolymer can be random, block, grafted, or any possible structure, having at least one co-monomer in the chain backbone.

The cavitating agent may further comprise organic or inorganic nano-particles. Suitable examples include, but are not limited to, nanoclays, rigid polymers of high T_{g}, cross-linked polymers, metals, metal complexes such as metal oxides or nitrides, carbon nanotubes, ceramics, ceramic complexes, and combinations thereof. The nano-particles may help to increase the modulus, rigidity and thermal property of the cavitating agent and thus to improve the voiding performance of the cavitating agent.

The cavitating agent can be added to any layer of the film. The amount of the cavitating agent to be incorporated is not particularly limited and may correspond to the desired degree of void formation upon stretching. The film may comprise a cavitating agent or a blend of the cavitating agents in an amount of about 0.5 to about 70%, about 1 to about 60%, about 3 to about 60%, about 5 to about 50%, about 5 to about 30%, about 5 to about 20%, or about 5 to about 15%, based on the total weight of the layer to which the cavitating agent is added.

### Manufacture

The films according to the present invention may be prepared by any suitable means. Preferably, the film is co-extruded, cast, oriented, and then prepared for its intended use such as by coating, printing, slitting, or other converting methods.

Typically, the film is formed by coextruding the intermediate layer together with the first and second layers through a flat sheet extruder die at a temperature ranging from between about 200 to about 275° C., casting the film onto a cooling drum and quenching the film. The sheet is then stretched about 4 to about 6 times in the machine direction (MD) followed by stretching about 6 to about 10 times in the transverse direction (TD). The film is then wound onto a reel. Optionally, one of the external surfaces is flame or corona treated before winding.

The multilayered film may also comprise additional coatings and/or layers such as an adhesive layer (e.g., a water-based urethane coating) and/or a metallized polyester layer. The intermediate layer usually represents about 70 to about 90% of the thickness of the total multilayer film. The skin layers are usually coextensively applied to each major surface of the intermediate layer, typically by coextrusion, as noted above. The first or second layers may not, ultimately, be the outermost layers.

The films of the invention are useful as labels, and are particularly useful in the cut-and-stack labeling method. Labels containing these films have applications such as for containers, e.g., bottles or cans, for beverages or other liquid products such as lotions, beauty supplies, or cleaning solutions.

### Test Methods

The thicknesses of the film and the film's layers is measured by a micrometer or microscope. Stiffness is measured using a Gurley™ equipment. According to the manufacturer's website, Gurley™ bending resistance/stiffness testers are based on the same physical principle. Each instrument consists of a balanced pendulum or pointer which is center-pivoted and can be weighted at three points below its center. The pointer moves freely in both left and right directions on cylindrical jewel bearings which make the mechanism highly sensitive even to light-weighted materials. A sample of a specific size is attached to a clamp (parallel for flat sheet materials and tubing clamp for catheters, etc.), which in turn is located on one of several positions on a motorized arm which also moves left and right. The bottom 0.25″ (0.635 cm) of the sample overlaps the top of the pointer (a triangular shaped “vane”). During the test the sample is moved against the top edge of the vane, moving the pendulum until the sample bends and releases it. On manual/motorized models, the technician must observe the test to discern the maximum displacement of the pointer on the scale. The value (for flat sheet materials) reached is then located on a conversion chart to arrive at the appropriate bending resistance/stiffness measurement. On digital models, the point of release is automatically measured by an optical encoder and displayed on a digital readout. This readout continuously displays readings from tests performed in both the left and right directions. In addition, the on-board microprocessor automatically computes and displays the average of left and right stiffness data after each measurement is performed. For flat sheet materials, the operator can then press a button to automatically convert the point-of-release reading on the display to force (milligrams) which then can be multiplied by a constant for bending moment (gram-centimeters or millinewton-meters).

### EXAMPLES

Each of the example films are made with the components in Table 1, with variations in thickness and in the amount of non-migratory slip agent (MB 50-001). Table 2 illustrates films of the invention and their properties. The cutting, sheeting, and stacking of these films were evaluated and determined to be very good. The films sheeted and printed at normal operating speeds of 7000-8000 sheets/hour, and demonstrated fitness for use (FFU) at the printer.

TABLE 1
Exemplary Film Structures

| Component | First layer | Intermediate layer | Second layer |
|---|---|---|---|
| Polymer | Fina 8573 | Exxon 4712 | Fina 8573 |
| | | Exxon 4712 | |
| | | (10%) | |
| | | RPP (10%) | |
| Non-migratory | | | Dow Corning MB 50- |
| slip additive | | | 001 (varied) |
| Antistatic | | Armostat 475 | |
| additive | | (2000 ppm) | |
| Antiblocking | Tospearl | | Tospearl 130 (500 ppm) |
| additive | 130 | | Seahostar KEP 150 |
| | (500 ppm) | | (3500 ppm) |

TABLE 2
Exemplary Film Structures and Physical Properties

| | | | | | | | COF I/O | |
|---|---|---|---|---|---|---|---|---|
| | | | Gurley Stiffness | | Surface Resistivity | | Static | Kinetic |
| Ex. | MB-50-001 | Thickness | MD | TD | Inside | Outside | Ave | Ave |
| 1 | 0.625% | 50 μm | 11.305 | 20.850 | discharge | N/A | 0.195 | 0.206 |
| 2 | 0.625% | 57 μm | 15.475 | 29.361 | discharge | 12.477 | 0.173 | 0.178 |
| 3 | 0.312% | 57 μm | 14.549 | 27.429 | discharge | 12.352 | 0.225 | 0.223 |
| 4 | 0.312% | 50 μm | 12.047 | 21.313 | discharge | 11.642 | 0.171 | 0.174 |

| | COF I/I | | COF O/O | |
|---|---|---|---|---|
| | Static | Kinetic | Kinetic | Kinetic |
| Ex. | Ave | Ave | Ave | Ave |
| 1 | 0.207 | 0.213 | 0.214 | 0.219 |
| 2 | 0.194 | 0.201 | 0.125 | 0.143 |
| 3 | 0.195 | 0.200 | 0.216 | 0.208 |
| 4 | 0.179 | 0.173 | 0.163 | 0.178 |

All patents and patent applications, test procedures (such as ASTM methods, UL methods, and the like), and other documents cited herein are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

Embodiments of the invention include:

### Embodiment A

A film comprising:
(a) an intermediate layer comprising a polymer and an antistatic agent, said intermediate layer having a first side and a second side;
(b) a first layer comprising a polymer, said first layer being on the first side and is printed or printable; and
(c) a second layer comprising a polymer and a non-migratory slip agent, said second layer being on the second side,
wherein the film has at least one of (i) a thickness of at least about 30 μm, (ii) a static coefficient of friction of about 0.15 to less than 0.30, and (iii) a kinetic coefficient of friction of about 0.15 to less than 0.30.

### Embodiment B

The film of Embodiment A in the form of a sheet suitable for feeding to a cut-and-stack labeling equipment.

### Embodiment C

The film of Embodiments A or B having a static and/or kinetic coefficient of friction (I/O) of about 0.15 to less than 0.30.

### Embodiment D

The film of any of the preceding Embodiments having a static and/or kinetic coefficient of friction (I/O) of about 0.17 to about 0.25.

### Embodiment E

The film of any of the preceding Embodiments having a thickness of at least about 30 μm, a static coefficient of friction of about 0.15 to less than 0.30, and a kinetic coefficient of friction of about 0.15 to less than 0.30.

### Embodiment F

The film of any of the preceding Embodiments having a stiffness of at least about 10 Gurley in MD.

### Embodiment G

The film of any of the preceding Embodiments having a stiffness of at least about 20 Gurley in TD.

### Embodiment H

The film of any of the preceding Embodiments having a thickness of at least about 50 μm.

### Embodiment I

The film of any of the preceding Embodiments, wherein the antistatic agent comprises at least one of an alkali metal sulfonate, a polyalkylphenylsiloxane, or a tertiary amine.

### Embodiment J

The film of any of the preceding Embodiments, wherein the antistatic agent is present in an amount of about 0.01% to about 2% by weight of the intermediate layer.

### Embodiment K

The film of any of the preceding Embodiments, wherein the non-migratory slip agent comprises silicone gum.

### Embodiment L

The film of any of the preceding Embodiments, wherein the non-migratory slip agent is present in an amount of about 0.1% to about 1% by weight of the second layer.

### Embodiment M

The film of any of the preceding Embodiments, wherein the polymer in the intermediate layer comprises at least one of a polypropylene homopolymer, polyethylene, ethylene-propylene copolymer, propylene-butene copolymer, or ethylene-propylene-butylene terpolymer.

### Embodiment N

The film of any of the preceding Embodiments, wherein the intermediate layer further comprises a cavitating agent.

### Embodiment O

The film of any of the preceding Embodiments, wherein the polymer in at least one of the first and second layers comprises at least one of a polypropylene homopolymer, polyethylene, ethylene-propylene copolymer, propylene-butene copolymer, or ethylene-propylene-butylene terpolymer.

### Embodiment P

The film of any of the preceding Embodiments, wherein at least one of the first and second layers further comprises an antiblocking agent.

### Embodiment Q

The film of any of the preceding Embodiments, further comprising a third layer between the first layer and the intermediate layer or between the second layer and the intermediate layer.

### Embodiment R

A film comprising:
(a) an intermediate layer comprising an isotactic polypropylene homopolymer and an antistatic agent comprising at least one of an alkali metal sulfonate, a polyether-modified polydiorganosiloxane, or a tertiary amine, said intermediate layer having a first side and a second side;
(b) a first layer comprising a propylene-ethylene random copolymer, said first layer being on the first side and is printed or printable; and
(c) a second layer comprising an ethylene-propylene copolymer and silicone gum, said second layer being on the second side, wherein the silicone gum is in an amount of about 0.1% to about 1% by weight of the second layer,
wherein the cut-and-stack film has a stiffness of at least about 10 Gurley in MD and at least about 20 Gurley in TD, a thickness of at least about 50 μm, a static coefficient (I/O) of friction of about 0.17 to about 0.25, and a kinetic coefficient of friction (I/O) of about 0.17 to about 0.25.

### Embodiment S

A cut-and-stack label made from the film of any of the preceding Embodiments.

### Embodiment T

A method for producing a film, comprising:
(a) providing an intermediate layer comprising a polymer and an antistatic agent, said intermediate layer having a first side and a second side;
(b) providing a first layer comprising a polymer, said first layer being printed or printable;
(c) providing a second layer comprising a polymer and a non-migratory slip agent; and
(d) forming a film wherein the first layer is on the first side of the intermediate layer and the second layer is on the second side of the intermediate layer,
wherein the film has at least one of (i) a thickness of at least about 30 μm, (ii) a static coefficient of friction of about 0.15 to less than 0.30, and (iii) a kinetic coefficient of friction of about 0.15 to less than 0.30.

### Embodiment U

The method of Embodiment T, further comprising:
(e) cutting the film into sheets; and
(f) forming a stack of sheets suitable for feeding to a cut-and-stack labeling equipment.

### Embodiment V

The method of Embodiments T or U, further comprising:
(g) feeding the sheets into a cut-and-stack labeling equipment; and
(h) printing the sheets on the side of the first layer.

### Embodiment W

The method of any of Embodiment T or subsequent Embodiments, wherein the film has a static and/or kinetic coefficient of friction of about 0.15 to less than 0.30.

### Embodiment X

The method of any of Embodiment T or subsequent Embodiments, wherein the film has a static and/or kinetic coefficient of friction of about 0.17 to about 0.25.

### Embodiment Y

The method of any of Embodiment T or subsequent Embodiments, wherein the film has a thickness of at least about 30 μm, a static coefficient of friction of about 0.15 to less than 0.30, and a kinetic coefficient of friction of about 0.15 to less than 0.30.

### Embodiment Z

The method of any of Embodiment T or subsequent Embodiments, wherein the film has a stiffness of at least about 10 Gurley in MD.

### Embodiment AA

The method of any of Embodiment T or subsequent Embodiments, wherein the film has a stiffness of at least about 20 Gurley in TD.

### Embodiment BB

The method of any of Embodiment T or subsequent Embodiments, wherein the film has a thickness of at least about 50 μm.

### Embodiment CC

The method of any of Embodiment T or subsequent Embodiments, wherein the antistatic agent comprises at least one of an alkali metal sulfonate, a polyalkylphenylsiloxane, or a tertiary amine.

### Embodiment DD

The method of any of Embodiment T or subsequent Embodiments, wherein the antistatic agent is present in an amount of about 0.01% to about 2% by weight of the intermediate layer.

### Embodiment EE

The method of any of Embodiment T or subsequent Embodiments, wherein the non-migratory slip agent comprises silicone gum.

### Embodiment FF

The method of any of Embodiment 20 or subsequent Embodiments, wherein the non-migratory slip agent is present in an amount of about 0.1% to about 1% by weight of the second layer.

### Embodiment GG

The method of any of Embodiment T or subsequent Embodiments, wherein the polymer in the intermediate layer comprises at least one of a polypropylene homopolymer, polyethylene, ethylene-propylene copolymer, propylene-butene copolymer, or ethylene-propylene-butylene terpolymer.

### Embodiment HH

The method of any of Embodiment T or subsequent Embodiments, wherein the intermediate layer further comprises a cavitating agent.

### Embodiment II

The method of any of Embodiment T or subsequent Embodiments, wherein the polymer in at least one of the first and second layers comprises at least one of a polypropylene homopolymer, polyethylene, ethylene-propylene copolymer, propylene-butene copolymer, or ethylene-propylene-butylene terpolymer.

### Embodiment JJ

The method of any of Embodiment T or subsequent Embodiments, wherein at least one of the first and second layers further comprises an antiblocking agent.

### Embodiment KK

A label made according to the process of any of Embodiment U or subsequent Embodiments.

1. A film comprising:
(a) an intermediate layer comprising a polymer and an antistatic agent, said intermediate layer having a first side and a second side;
(b) a first layer comprising a polymer, said first layer being on the first side and is printed or printable; and
(c) a second layer comprising a polymer and a non-migratory silicon gum slip agent, said second layer being on the second side and being untreated,
wherein the film has at least one of (i) a thickness of at least about 30 μm, (ii) a static coefficient of friction (I/O) of about 0.15 to less than 0.30, and (iii) a kinetic coefficient of friction (I/O) of about 0.15 to less than 0.30.

2. The film of claim 1 in the form of a sheet suitable for feeding to a cut-and-stack labeling equipment.

3. The film of claim 1 having a static and/or kinetic coefficient of friction (I/O) of about 0.15 to less than 0.30.

4. The film of claim 1 having a static and/or kinetic coefficient of friction (I/O) of about 0.17 to about 0.25.

5. The film of claim 1 having a thickness of at least about 30 μm, a static coefficient of friction of about 0.15 to less than 0.30, and a kinetic coefficient of friction of about 0.15 to less than 0.30.

6. The film of claim 1 having a stiffness of at least about 10 Gurley in MD.

7. The film of claim 1 having a stiffness of at least about 20 Gurley in TD.

8. The film of claim 1 having a thickness of at least about 50 μm.

9. The film of claim 1, wherein the antistatic agent comprises at least one of an alkali metal sulfonate, a polyalkylphenylsiloxane, or a tertiary amine.

10. The film of claim 1, wherein the antistatic agent is present in an amount of about 0.01% to about 2% by weight of the intermediate layer.

11. (canceled)

12. The film of claim 1, wherein the non-migratory slip agent is present in an amount of about 0.1% to about 1% by weight of the second layer.

13. The film of claim 1, wherein the polymer in the intermediate layer comprises at least one of a polypropylene homopolymer, polyethylene, ethylene-propylene copolymer, propylene-butene copolymer, or ethylene-propylene-butylene terpolymer.

14. The film of claim 1, wherein the intermediate layer further comprises a cavitating agent.

15. The film of claim 1, wherein the polymer in at least one of the first and second layers comprises at least one of a polypropylene homopolymer, polyethylene, ethylene-propylene copolymer, propylene-butene copolymer, or ethylene-propylene-butylene terpolymer.

16. The film of claim 1, wherein at least one of the first and second layers further comprises an antiblocking agent.

17. The film of claim 1, further comprising a third layer between the first layer and the intermediate layer or between the second layer and the intermediate layer.

18. A film comprising:
(a) an intermediate layer comprising an isotactic polypropylene homopolymer and an antistatic agent comprising at least one of an alkali metal sulfonate, a polyether-modified polydiorganosiloxane, or a tertiary amine, said intermediate layer having a first side and a second side;
(b) a first layer comprising a propylene-ethylene random copolymer, said first layer being on the first side and is printed or printable; and
(c) a second layer comprising an ethylene-propylene copolymer and silicone gum, said second layer being on the second side and being untreated, wherein the silicone gum is in an amount of about 0.1% to about 1% by weight of the second layer,
wherein the cut-and-stack film has a stiffness of at least about 10 Gurley in MD and at least about 20 Gurley in TD, a thickness of at least about 50 μm, a static coefficient of friction (I/O) of about 0.17 to about 0.25, and a kinetic coefficient of friction (I/O) of about 0.17 to about 0.25.

19. A cut-and-stack label made from the film of claim 1.

20. A method for producing a film, comprising:
(a) providing an intermediate layer comprising a polymer and an antistatic agent, said intermediate layer having a first side and a second side;
(b) providing a first layer comprising a polymer, said first layer being printed or printable;
(c) providing a second layer comprising a polymer and a non-migratory silicon gum slip agent; and
(d) forming a film wherein the first layer is on the first side of the intermediate layer and the second layer is on the second side of the intermediate layer and being untreated,
wherein the film has at least one of (i) a thickness of at least about 30 μm, (ii) a static coefficient of friction (I/O) of about 0.15 to less than 0.30, and (iii) a kinetic coefficient of friction (I/O) of about 0.15 to less than 0.30.

21. The method of claim 20, further comprising:
(e) cutting the film into sheets; and
(f) forming a stack of sheets suitable for feeding to a cut-and-stack labeling equipment.

22. The method of claim 21, further comprising:
(g) feeding the sheets into a cut-and-stack labeling equipment; and
(h) printing the sheets on the side of the first layer.

23. A label made according to the process of claim 22.
